(19) United States
(12) Patent Application Publication
(10) Pub. No.: US 2025/0247460 A1
(43) Pub. Date: Jul. 31, 2025

(54) Visual Noise Indicator and Feedback

(71) Applicant: Bose Corporation, Framingham, MA (US)

(72) Inventors: David Kitendaugh, Newton, MA (US); Todd Richard Reily, North Reading, MA (US); Jenna Marie Duggan-Lykes, Hyde Park, MA (US); Paul Franzosa, Arlington, MA (US); Colin Douglas Fletcher, Needham, MA (US); Andrew Todd Sabin, Chicago, IL (US); Eric Eugene Dolecki, Holliston, MA (US); Marko Stamenovic, Jamaica Plain, MA (US)

(21) Appl. No.: 19/034,930

(22) Filed: Jan. 23, 2025

Related U.S. Application Data
(60) Provisional application No. 63/624,834, filed on Jan. 25, 2024.

(51) Int. Cl. H04M 1/72409; H04M 1/22; H04M 1/72412; H04M 1/72469

(52) U.S. Cl. CPC H04M 1/724097; H04M 1/22; H04M 1/72469; H04M 1/72412

(57) ABSTRACT

Various implementations include approaches and devices for providing feedback on noise in a communication mode. In particular cases, a method includes: detecting use of a communication mode by an audio device, and providing a visual indicator that a de-noise system is available to mitigate noise in the communication mode.

### PRIORITY CLAIM

This application claims priority to U.S. Provisional Patent Application No. 63/624,834 (filed Jan. 25, 2024), the entire contents of which are hereby incorporated by reference.

### TECHNICAL FIELD

This disclosure generally relates to audio systems. More particularly, the disclosure relates to control devices for audio systems.

### BACKGROUND

When operating a device in a communication mode, e.g., using a smart device or other audio gateway, ambient noise at the first user in the communication mode can be transmitted to one or more additional users on the other end of the communication. In certain cases, the first user is aware of the noise and may take steps to mitigate noise received at the other end of the communication. In other cases, the first user is not fully aware of the level of noise in the environment. In further cases, the first user may be unaware that a de-noise system can aid in reducing noise received at the other end of the communication and/or that such a de-noise system is actively running.

### SUMMARY

All examples and features mentioned below can be combined in any technically possible way.

Various implementations include devices and approaches for providing a visual indication of noise in a communication mode.

In some particular aspects, a method includes: detecting use of a communication mode by an audio device, and providing a visual indicator that a de-noise system is available to mitigate noise in the communication mode.

In additional particular aspects, an audio device includes: an electro-acoustic transducer; a microphone; and a controller coupled with the electro-acoustic transducer and the microphone, the controller configured to: detect use of a communication mode by the audio device, and send instructions to a connected display device to provide a visual indicator that a de-noise system is available to mitigate noise in the communication mode.

In further particular aspects, a system includes: a visual display; a communications system; and a controller coupled with the visual display and the communications system, the controller configured to: detect use of a communication mode by a connected audio device; and provide an indicator at the visual display that a de-noise system is available to mitigate noise in the communication mode.

Implementations may include one of the following features, or any combination thereof.

In some cases, the method further includes detecting noise in ambient sound during use of the communication mode.

In certain aspects, the method further includes: comparing the detected noise with a threshold, and activating the de-noise system in response to the detected noise satisfying the threshold.

In some examples, the threshold includes a range of noise values. In particular cases, the threshold can be dynamic. In other cases, the threshold is fixed. In various implementations, the threshold can be based on user preferences. In some cases, the threshold can vary based on a detected location of the device. In particular cases, the threshold is a value or a range of values such as decibels (dB) and/or a value or range of multiple values such as dB, frequency, and/or other features of an acoustic signature.

In some implementations, the threshold is based on a type of the audio device. In certain examples, the threshold varies based on a type of the audio device. In one example, an occluding wearable audio device has a distinct threshold than a non-occluding wearable audio device. In further examples, a device running an active noise reduction (ANR) system has a distinct threshold than a device not running an ANR system.

In particular cases, the method further includes altering the visual indicator to indicate that the de-noise system is active.

In some aspects, the method further includes adjusting the visual indicator in response to a change in the detected noise.

In particular implementations, the visual indicator includes at least one of a progressive or regressive indicator function that is updated in response to the changes in detected noise.

In certain cases, the visual indicator further indicates activity of the de-noise system.

In some aspects, the method further includes providing a prompt to activate the de-noise system in response to detecting noise in ambient sound during use of the communication mode.

In particular cases, the audio device comprises a wearable audio device.

In some aspects, the wearable audio device comprises an occluding wearable audio device. In particular examples, the occluding wearable audio device includes a set of earbuds or earphones.

In certain implementations, the communication mode includes at least one of a phone call, a video call, or a meeting including audio communication. In some examples, the meeting can include a virtual reality or augmented reality meeting or a conference meeting.

In particular aspects, the visual indicator is presented on visual interface and enables activation of the de-noise system with a command at the interface.

In some cases, the visual indicator includes an icon that is present at an interface in both an active mode and an inactive mode.

In particular implementations, the visual indicator is presented to a first user of the communication mode and includes a representation of an amount of noise that is detectable by a second user of the communication mode.

In certain cases, the visual indicator includes a multi-function indicator. In some examples, the multi-function indicator can indicate at least one of: on/off or progression/regression of the de-noise function. In certain examples, the multi-function indicator can include variations in at least one of color, shading, fill, or illumination.

In particular aspects, the audio device comprises a vehicle audio system and the visual indicator is provided on a vehicle interface.

In some cases, the visual indicator is provided on a smart device or a computing device acting as an audio gateway device.

In certain implementations, an audio device includes a plurality of electro-acoustic transducers. In some examples, an audio device includes a plurality of microphones, e.g., one or more microphone arrays.

In certain cases, the controller at the audio device is further configured, using the microphone, to detect noise in ambient sound during use of the communication mode.

In certain cases, the controller at the audio device is further configured to: compare the detected noise with a threshold, and activate the de-noise system in response to the detected noise satisfying the threshold. In particular examples, the de-noise system is activated locally at the wearable audio device and/or an audio gateway device such as a smart device. In some cases, the de-noise system includes a de-noise algorithm that can include a machine learning (ML) component trained to detect and suppress noise.

In some cases, the controller at the audio device provides a prompt to activate the de-noise system in response to detecting noise in ambient sound during use of the communication mode.

In certain cases, the communication mode is managed by an audio gateway device such as a smart phone, smart device, vehicle audio system, or conference audio system.

In some aspects, the visual indicator is presented on visual interface at the connected display device and enables activation of the de-noise system with a command at the visual interface.

In particular cases, the audio device is an occluding wearable audio device.

In some aspects, the controller in the system is configured to detect noise in ambient sound during use of the communication mode.

In certain implementations, the controller in the system is further configured to: compare the detected noise with a threshold, and activate the de-noise system in response to the detected noise satisfying the threshold.

In some aspects, a smart device includes the system.

In further aspects, a vehicle audio system includes the system.

In additional implementations, processing that detects use of the communication mode by the audio device and provides the visual indicator is performed at a smart device or a computing device.

In further implementations, processing that detects use of the communication mode by the audio device is performed at the audio device.

In additional cases, a method further includes receiving an input from a user interface including a sensor at the audio device.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including a control device and an audio device according to various disclosed implementations.

FIGS. 2-4 illustrate example interfaces with visual noise indicators according to various implementations.

FIG. 5 is a flow diagram illustrating processes in a method according to various implementations.

FIG. 6 is a flow diagram illustrating processes in a method according to various additional implementations.

FIGS. 7-10 illustrate additional example interfaces and control features in visual noise reduction indication according to various implementations.

FIG. 11 shows non-limiting examples of types of visual noise indicators according to various implementations.

FIG. 12 shows a display including a visual noise indicator according to various additional implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that approaches, audio devices, and systems with a visual indicator of noise and/or noise feedback functions in a communication mode can beneficially enhance the user experience. Such approaches, devices, and systems can be particularly beneficial for users wearing occluding or at least partially occluding audio devices such as earbuds or headphones.

As noted herein, conventional approaches for noise control in communication modes are either performed behind the scenes (e.g., running as de-noise algorithms without user interaction) or are not effectively presented to a user.

In contrast to conventional approaches and systems, various implementations include approaches that detect a communication mode by an audio device (e.g., headphones, earphones, a vehicle audio system, etc.) and provide a visual indicator that a de-noise system is available to mitigate noise in the communication mode. In particular cases, the approach includes detecting noise in ambient sound during use of the communication mode, comparing that noise to a threshold, and activating the de-noise system if the noise satisfies (e.g., meets or exceeds) the threshold. In particular examples, the visual indicator indicates activity of the de-noise system, and in more particular examples, reflects (e.g., dynamically) changing activity of the de-noise system.

Commonly labeled components in the FIGURES are considered to be substantially equivalent components for the purposes of illustration, and redundant discussion of those components is omitted for clarity.

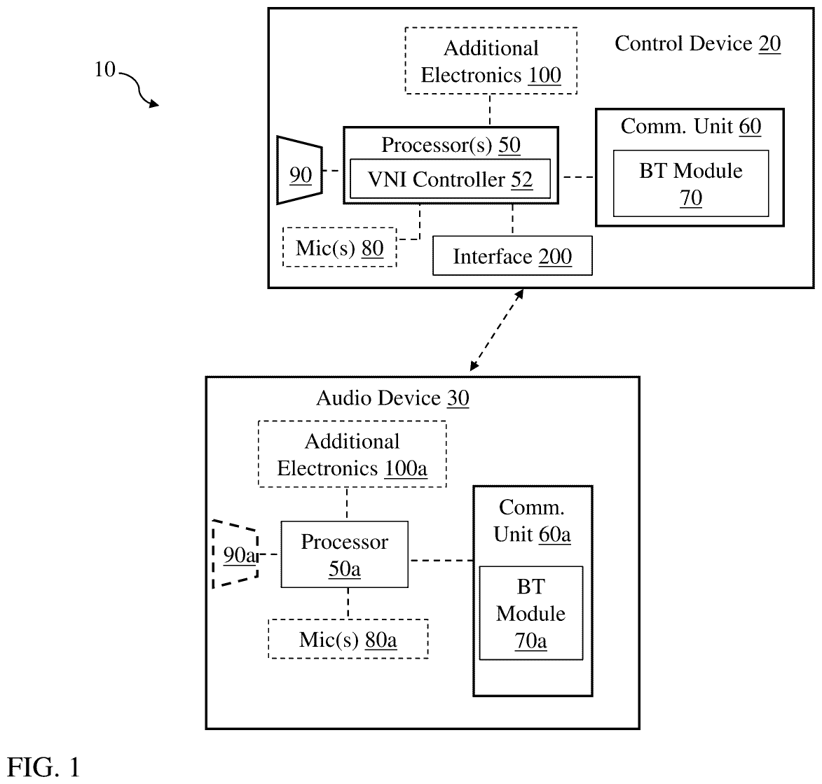

FIG. 1 shows an example of a system 10 including a set of devices according to various implementations. In various implementations, the devices shown in system 10 include a control device (or simply, device) 20 and an audio device 30 that is connected (e.g., wirelessly, such as via a wireless pairing and/or via a hard-wired connection) with the control device 20. As described herein, in various implementations, the control device 20 is physically separate (or, remote) from the audio device 30. However, in other implementations described further herein, features of the control device 20 can be integrated in the audio device 30, e.g., in a common housing. In particular examples, the control device 20 includes a smart device that can act as an audio gateway, such as a smart phone, tablet, computing device, etc. In further cases, one or more functions of the control device 20 are performed (e.g., executed) at the audio device 30. In certain cases, additional device(s) can be configured to communicate with the control device 20 and/or audio device 30 using any communications protocol or approach described herein.

Aspects and implementations disclosed herein may be applicable to personal audio devices that either do or do not support two-way communications, and either do or do not support active noise reduction (ANR). For personal audio devices that do support either two-way communications or ANR, it is intended that what is disclosed and claimed herein is applicable to a personal audio device incorporating one or more microphones disposed on a portion of the personal audio device that remains outside an ear when in use (e.g., feedforward microphones), on a portion that is inserted into a portion of an ear when in use (e.g., feedback microphones), or disposed on both of such portions. Still other implementations of personal audio devices to which what is disclosed and what is claimed herein is applicable will be apparent to those skilled in the art.

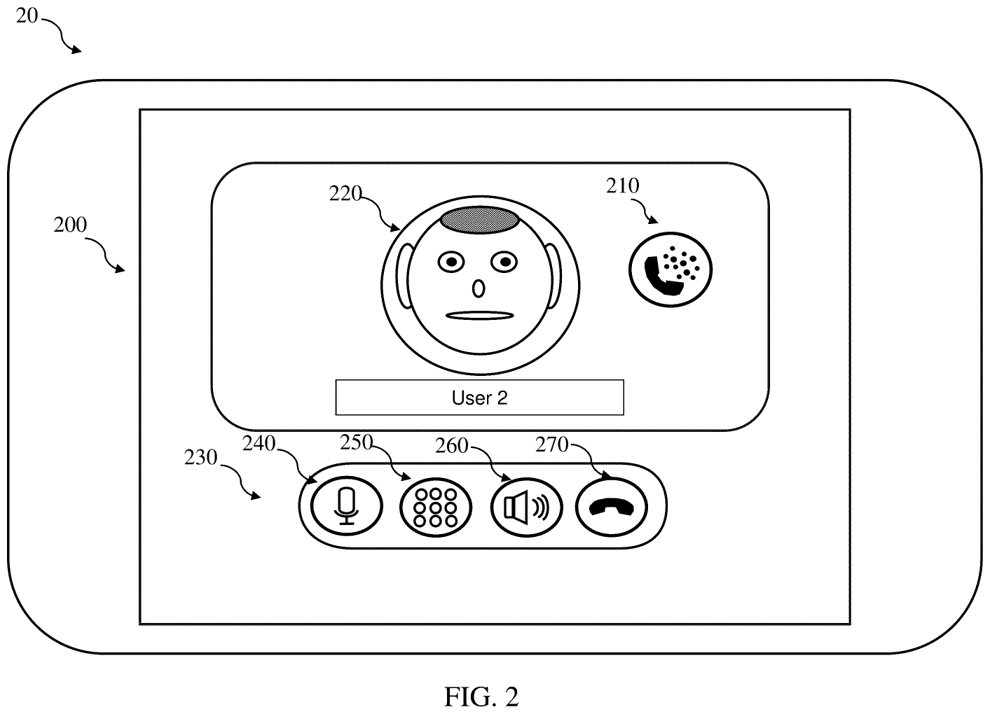

In certain cases, the control device 20 includes one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In certain example implementations, control device 20 can also include an interface 200 having at least one visual component, e.g., a user interface such as a graphical user interface (GUI), capacitive touch interface, touch screen, etc. FIG. 2 illustrates one example of an interface 200 including a visual indicator 210 of a de-noise system according to various implementations. Additional aspects of the visual indicator 210 are described further herein.

Returning to FIG. 1, in addition to processor 50a, the audio device 30 can also include one or more microphones 80 (e.g., a microphone array), and a transducer 90 (e.g., an electro-acoustic transducer) for providing an audio output, e.g., to a user. Further, the control device 20, audio device 30, and/or additional device(s) not shown in the environment can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). In particular cases, memory stores: a microcode of a program for processing and controlling the processor(s) 50 and a variety of reference data; data generated during execution of any of the variety of programs performed by the processor(s) 50; a Bluetooth connection process; and/or various updateable data for safekeeping such as paired device data, connection data, device contact information, etc. Certain of the above-noted components depicted in FIG. 1 are optional, and are displayed in phantom. For example, in some cases, audio device 30 need not necessarily include a transducer 90. In such cases, the audio device 30 can include an amplifier (e.g., in additional electronics 100) configured to amplify an audio signal for output at an additional device (e.g., another audio device such as headphones or earphones).

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

In particular cases, the processor(s) 50 may provide, for example, for coordination of other components of the device 20, such as control of user interface 200 and applications run by the device 20. In various implementations, processor(s) 50 in device 20 includes a control module which can include software and/or hardware for performing control processes described herein. For example, processor(s) 50 can include a visual noise indicator (VNI) control module (or simply, controller) 52 in the form of a software stack having instructions for controlling functions visually depicting noise and/or de-noise functions according to any implementation described herein.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 30 and/or additional devices via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, audio device 30 and/or additional devices can include similar components (e.g., a processor 50 and communications unit 60) as the control device 20. Further, audio device 30 can include additional components that may not necessarily be present at the control device 20 (e.g., a transducer 90 and microphone(s) 80).

As described herein, control device 20 can act as an audio gateway for audio device 30 according to various implementations. The audio gateway may be implemented as any device capable of receiving a phone call, video call, or communications audio, and can include one of a mobile phone, a portable game player, a portable media player, a smart speaker system, a computer (e.g., PC or tablet), an audio/video (A/V) receiver as part of a home entertainment or home theater system, etc. Example configurations of a wireless audio system include an audio gateway capable of making and receiving phone calls (e.g., a cellular phone, personal data assistant (PDA), tablet, personal computer (PC), wearable communication system, or any other known audio gateway for initiating and/or receiving phone calls). The audio gateway can be paired with a set of wireless transceivers, which can include wirelessly connected headphones, earbuds, wearable audio devices, audio conference system(s), smart speakers, etc. In the example of a headphone system such as a wireless earbud headphone system, the wireless transceivers are wirelessly linked with the audio gateway (and each other) in order to perform call-related functions (e.g., receive/send call audio). It is understood that hard-wired communication between devices such as control device 20 and audio device 30 is also contemplated in accordance with the various implementations. Additional description of audio gateway functions is included, for example, in U.S. Pat. No. 10,356,232 (Dual-Transceiver Wireless Calling), issued on Jul. 16, 2019, the entire contents of which are incorporated by reference herein.

Further, the control device 20 can be configured to run a de-noise system according to various implementations. In certain cases, the de-noise system is run at the processor 50 at control device. In other cases, the de-noise system can be run at processor 50a at audio device 30, and/or be run as a distributed program among two or more connected devices. In various implementations, the de-noise system includes a module (or program) run by one or more processors and configured to remove detectable noise in communications. Examples of such de-noise systems are available in audio gateway software and are described as “noise suppression,” “voice isolation”, or “phone noise cancellation” by communication platforms provided, e.g., by Microsoft Corp. (Teams), Redmond, WA (USA) and Apple, Inc. (iOS), Cupertino, CA (USA). Such systems reduce (e.g., remove) noise from communication signals detected at one user's microphone(s) prior to sending those communication signals to a second user's speaker(s).

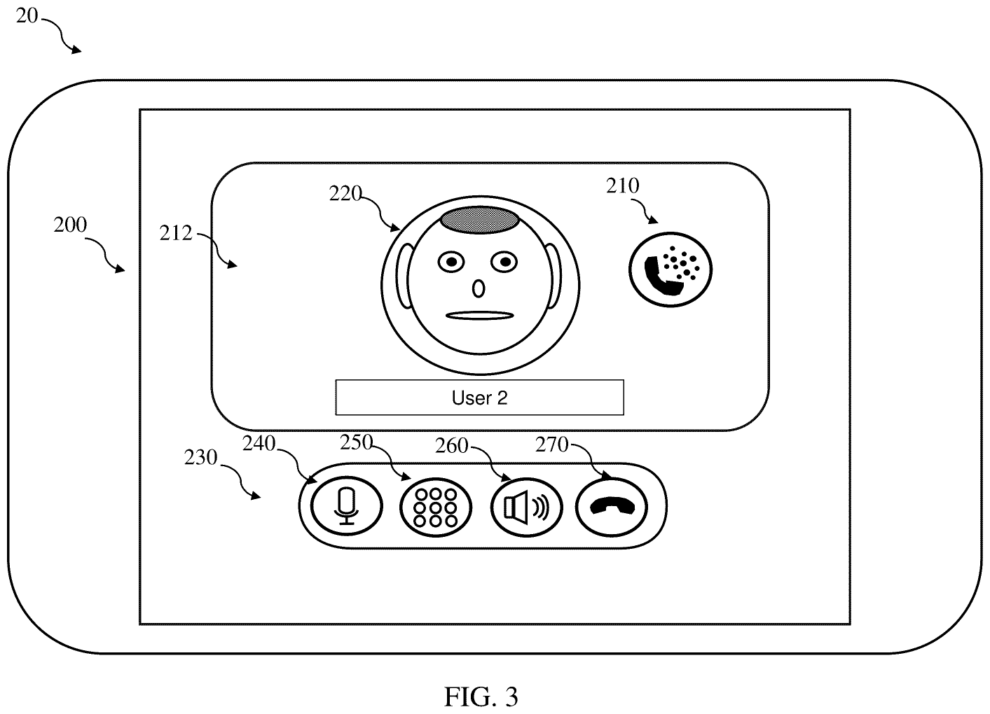

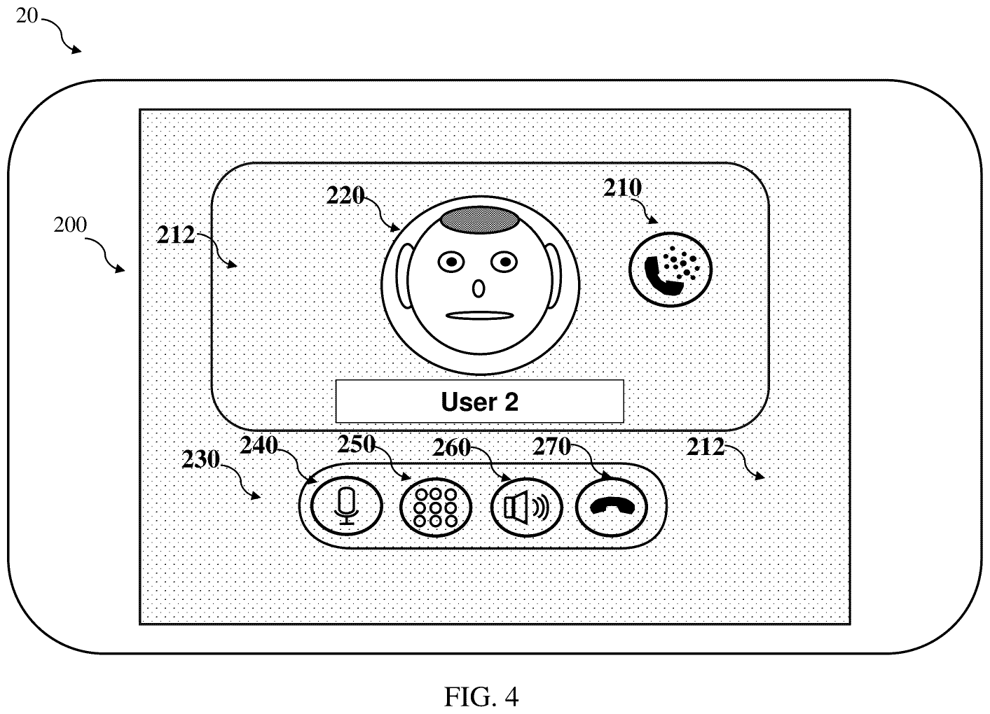

FIG. 2 shows a schematic view of a non-limiting example interface 200 on control device 20 (or on audio device 30 in certain cases) including one example of a visual indicator 210 according to various implementations. The control device 20 can take any of a number of distinct form factors, and the depiction in the FIGURES herein are merely illustrative. In certain cases, the visual indicator 210 includes an icon, button, or other visible contrast cue on the interface 200. As described herein, the interface 200 is a visual interface, e.g., a GUI, capacitive touch interface, touch screen, etc., and can be presented on the control device 20 or any other connected device such as a display, monitor, television, etc., in certain cases, the visual indicator 210 includes an icon that is present at the interface 200 in both an active mode and an inactive mode. For example, FIG. 2 illustrates the visual indicator 210 in an inactive (e.g., not illuminated) mode. In contrast, FIG. 3 shows the visual indicator 210 in an active (e.g., illuminated) mode. In certain cases, the visual indicator 210 includes a multi-function indicator, for example, providing feedback on the status of a de-noise system such as on/off and/or progression/regression, with changes shown in color, shading, illumination, fill, or other visible mechanisms. In the example of FIGS. 2 and 3, the indicator 210 is shown having differences in outline and brightness/color (e.g., highlight/blue outline versus faded/neutral/gray outline), and FIG. 4 shows a distinction from FIG. 3 in terms of progression in de-noise function as depicted by changes in the icon (indicator 210). In these cases, the number of dots (or, sparkles) illustrated and/or illuminated within the circular frame of the indicator 210 vary based on an amount of noise being detected in the environment near audio device 30 (and canceled by the de-noise system). In further implementations, features of the background 212 can also vary based on detected noise in the environment and/or activity of the de-noise system. In the example interfaces 200 shown in FIGS. 2-4, an icon 220 representing the second user (on the other end of the communication) is illustrated, along with additional communication control functions 230, such as microphone control 240, dial control 250, volume control 260 and terminate/end communication control 270.

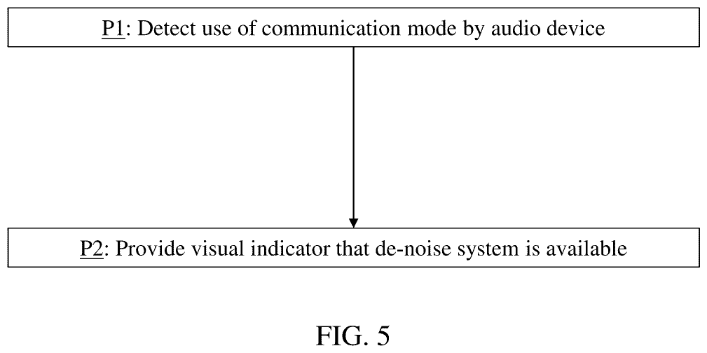

Turning to the flow diagram in FIG. 5 (with continuing reference to FIGS. 1-4, in various implementations, the VNI controller (or simply, controller) 52 can be configured to perform processes in managing the visual indicator 210 on an interface 200 (e.g., as shown in FIGS. 1-4). In one example, in a first process P1, controller 52 detects use of a communication mode by audio device 30. In certain cases, the controller 52 detects use of the communication mode via activity by the comm. unit 60 (e.g., BT module 70). In further implementations, the controller 52 detects use of the communication mode via activity by one or more communication software programs (or applications, or “apps”) running at the control device 20 and/or audio device 30. For example, the controller 52 can detect use of the communication mode based on activity by an audio and/or video conferencing application running at control device 20. In certain cases, the communication mode can include a phone call, video call, or a meeting that includes audio communication (e.g., a virtual reality or augmented reality meeting or meeting room). In various implementations, in response to detecting use of the communication mode, the controller 52 provides a visual indicator 210 that a de-noise system is available to mitigate noise in the communication mode (P2). In some cases, the indicator 210 is presented on the interface for the communication mode. For example, looking at FIG. 2, the controller 52 can be configured to provide indicator 210 as a default when the communication interface is displayed, e.g., with other controls such as controls 230. In further implementations, the controller 52 is configured to provide the indicator 210 only when communication is connected, e.g., audio is detected from another end of the communication.

In still further implementations, the controller 52 is configured to provide the indicator 210 only when one or more additional criteria is satisfied. In some cases, the indicator 210 is only provided when the audio device 30 has either a passive or active noise reduction characteristic, e.g., is an occluding audio device and/or has an active noise reduction (ANR) system. For example, in particular cases, the controller 52 is configured to provide the indicator 210 in response to detecting that the type of audio device 30 is an occluding audio device and/or that the audio device 30 is running an active noise reduction (ANR) system. An occluding audio device can include earbuds, over-ear headphones, or on-ear headphones that occlude (or cover) the user's ear or ear canal entrance. Such occluding audio devices can make the user less aware of the ambient noise, and as such, limit the user's ability to determine whether a second user in the communication mode could be detecting ambient noise during the communication. Further, an audio device 30 running an ANR system can make the user even less aware of the ambient noise that can be picked up as part of the communication audio. As such, the controller 52 can be configured to provide the indicator 210 in response to detecting a characteristic of the audio device 30 such as a noise reduction characteristic (passive and/or active). In particular cases, the control device 20 detects a characteristic of the audio device 30 such as a make/model or other device identifier to determine whether the audio device 30 has a noise reduction characteristic.

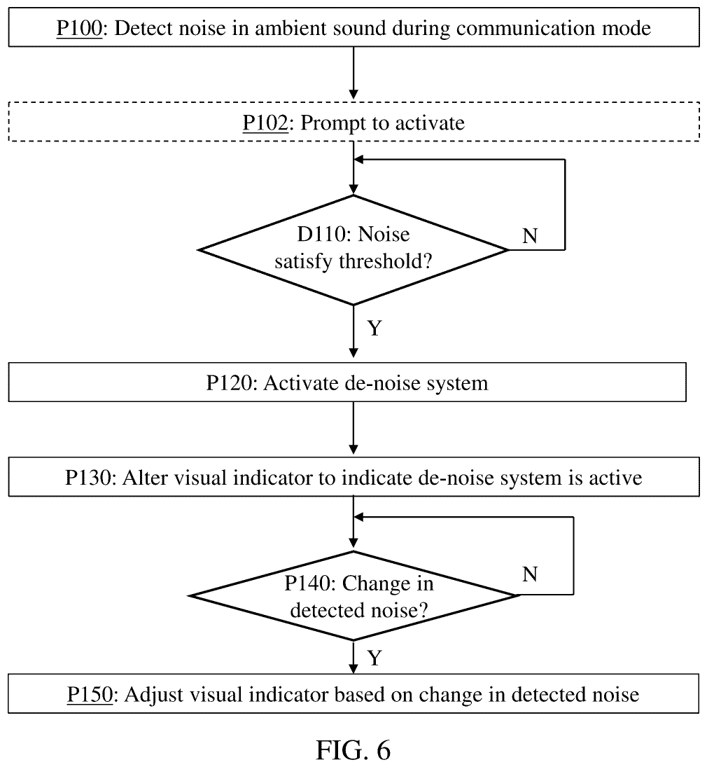

FIG. 6 illustrates additional processes performed in a method according to various implementations. These processes can be combined with any processes in other approaches described herein. In one process P100, the controller 52 detects noise in ambient sound during the communication mode. In various implementations, noise is detected using microphones 90 at one or more devices, e.g., control device 20 and/or audio device 30. In an optional process P102, in response to detecting noise in the ambient sound, the controller 52 prompts the user to activate the de-noise system, e.g., with a prompt at interface 200. In some cases, the prompt includes a highlighted icon, a flashing indicator, an audible indicator such as a ping combined with a visual indicator, etc. In certain of these cases, the controller 52 prompts the user to activate the de-noise system in response to detecting any noise in the ambient acoustic signals (e.g., via microphone(s) 90). If the user actuates the prompt, the controller 52 activates the de-noise system. In some cases, if the user does not actuate the prompt, the controller 52 will repeat the prompt after a period, or maintain the prompt for a period. In particular cases, the prompt is only visual, so as not to detract from the audio communication in progress.

In further cases, the controller 52 compares the detected noise with a threshold in decision D110, and if the noise satisfies the threshold (Yes), activates the de-noise system in process P120. If the noise does not satisfy the threshold (No to D110), the controller 52 can repeat the comparison (D110) on a continuous, periodic, or episodic basis. In various implementations, the threshold includes a range of noise values. In particular cases, the threshold can be dynamic. In other cases, the threshold is fixed. In various implementations, the threshold can be based on user preferences. In some cases, the threshold can vary based on a detected location of the device. In particular cases, the threshold is a value or a range of values such as decibels (dB) or hertz (Hz) and/or a value or range of multiple values such as dB, frequency, and/or other features of an acoustic signature. In some implementations, the threshold is based on a type of the audio device 20. In certain examples, the threshold varies based on a type of the audio device 20. In one example, an occluding wearable audio device has a distinct threshold than a non-occluding wearable audio device. In further cases, a wearable audio device with ANR functionality has a distinct threshold than a wearable audio device without ANR functionality.

In certain cases, the controller 52 is further configured (in P130) to alter the visual indicator 210 to indicate that the de-noise system is active, e.g., as illustrated in the comparison between FIGS. 2 and 3. The visual indicator 210 can be altered in terms of lighting, highlighting, coloring, location, font, accenting, etc.

In certain additional cases, when a change in noise is detected at decision D140, the controller 52 is configured to adjust the visual indicator 210 based on the change in detected noise (P150). For example, the controller 52 can be configured to illustrate progressive and/or regressive engagement of the de-noise system based on changes in detected noise.

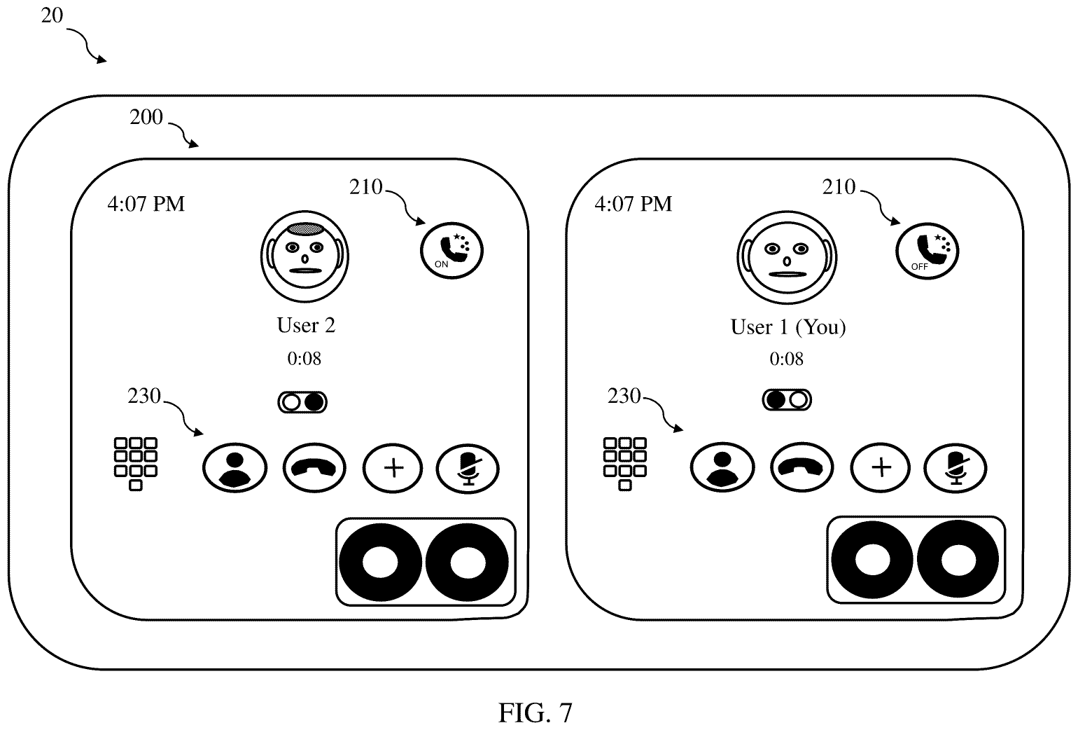

As noted herein, the visual indicator 210 can be presented in both an active mode and an inactive mode of the de-noise system, and in some cases, the visual indicator 210 is presented on the interface 200 and enables activation of the de-noise system with a command at the interface 200. In certain of these cases, the visual indicator 210 includes an actuatable icon such as a button, slider, etc., that can be actuated by a selection mechanism such as via a touch command, stylus command, mouse/pointer command, etc. FIG. 7 shows an example interface 200 including an icon 210 for both a first user (User 1) and a second user (User 2, at other end of communication). In this example, the controller 52 illustrates an active state of the de-noise system for the second user (e.g., “On”, highlighting, and/or coloring of indicator 210) and an inactive state of the de-noise system for the first user (E.g., “Off”, faded, and/or lack of color on indicator 210).

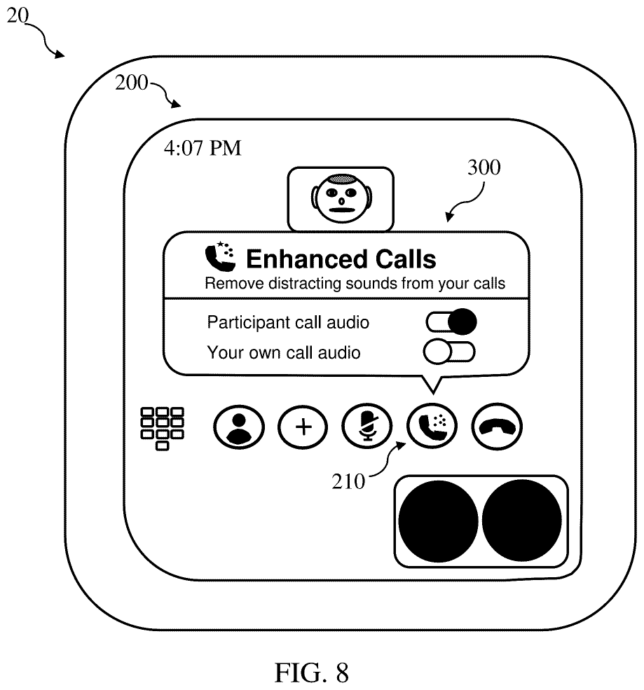

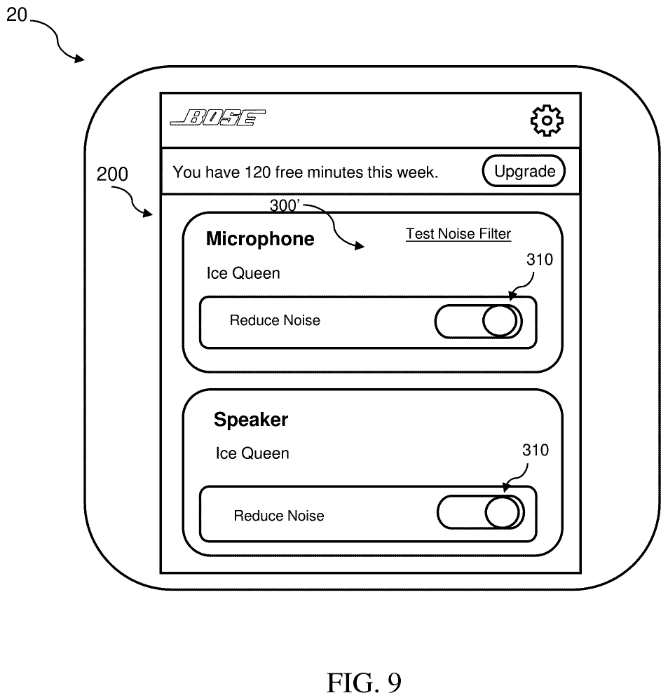

FIG. 8 shows another example of an interface 200 including a menu 300 for enabling the de-noise system for one or more participant in a communication mode. In this example, the menu 300 includes an option 310 (e.g., toggle, button, slider, etc.) to activate the de-noise system for one or more participants in a communication such as a call, video call, virtual meeting, etc. FIG. 9 shows another example of an interface 200 including another menu 300′ for enabling the de-noise system for a participant in a communication mode. In this example, the menu 300′ includes an option 310 (e.g., toggle, button, slider, etc.) to activate the de-noise system for one or more participants in a communication such as a call, video call, virtual meeting, etc.

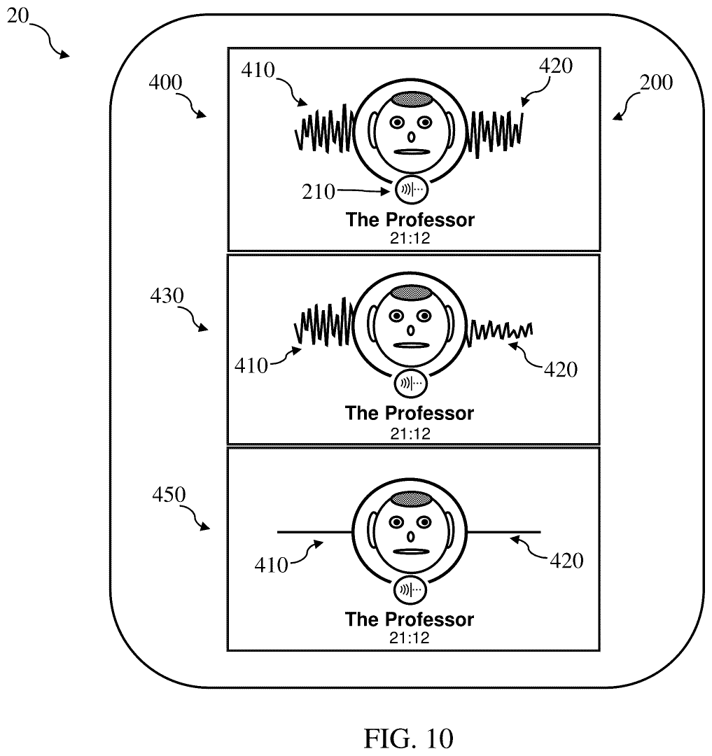

In various implementations, the visual indicator 210 is presented to a first user, e.g., the user of audio device 30, and can include a representation of an amount of noise that is detectable by a second user of the communication mode, e.g., a user on another end of the communication. In various implementations, the visual indicator 210 is configured to provide a dynamic representation of the amount of noise detectable by a second user of the communication mode. For example, FIG. 10 shows snapshots of an interface 200 with a visual indicator 210 of activity by an anti-noise system, in three phases: a first 400 illustrating the de-noise system as inactive and illustrating noise 410 detected in the communication signal on the left and noise 420 detected by the second user on the right, a second 430 illustrating the de-noise system as active and showing noise 410 detected in the communication signal on the left and (reduced) noise 420 to the second user on the right, and a third 450 illustrating the de-noise system as active and showing negligible noise 410 in both the communication signal on the left and the noise 420 to the second user.

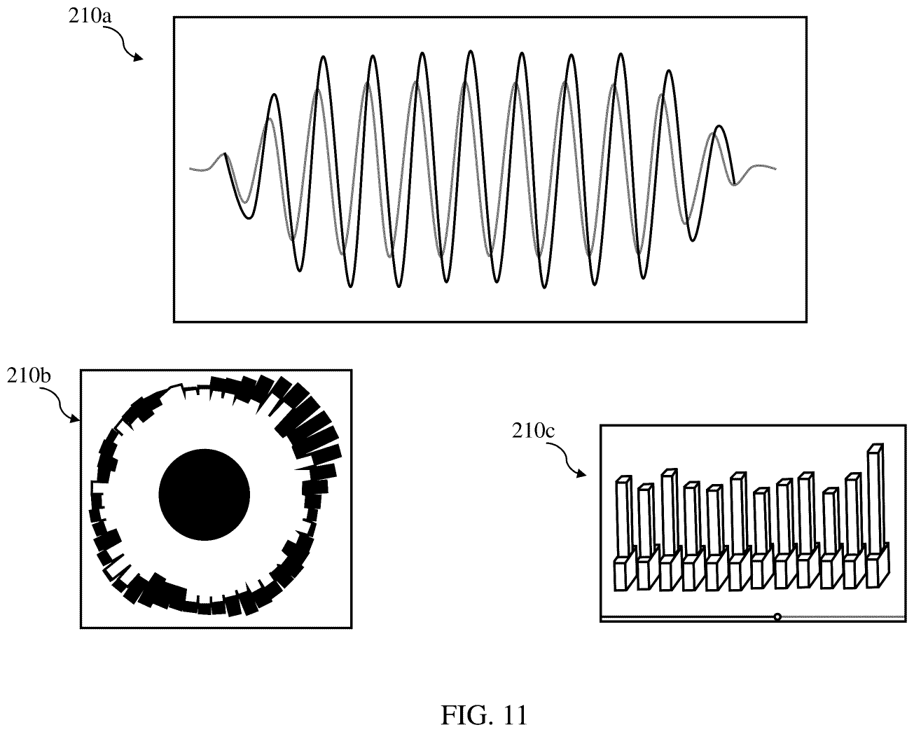

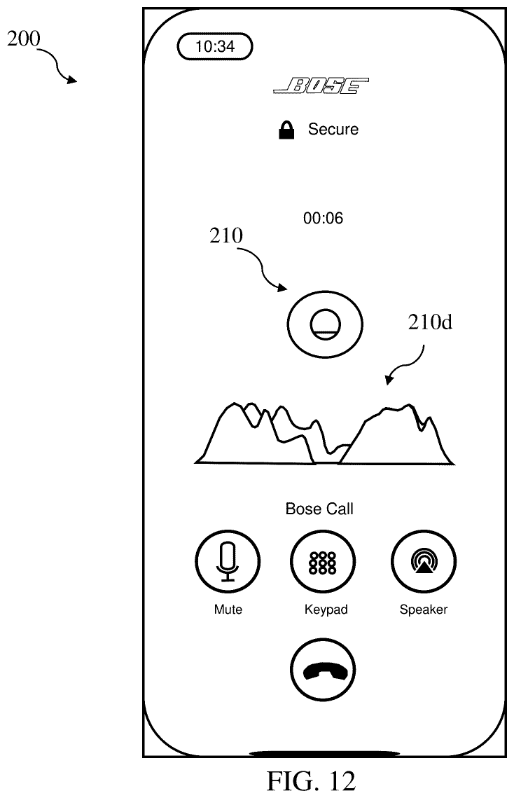

FIG. 11 shows three distinct examples of indicators 210a, 210b, 210c, certain of which include multi-function indicators, e.g., illustrating multiple functions of the de-noise system such as on/off and/or progression/regression, with changes shown in color, shading, illumination, fill, or other visible mechanisms. For example, 210a shows variations in detected noise and cancelation shown in color contrast (gray v. white) and wave (e.g., sine wave) size, 210b shows variations in detected noise and cancelation with color/shading contrast and dimension, and 210c shows variation in detected noise and cancelation with color/shading contrast and graphical depiction. FIG. 12 shows an example interface 200 with an indicator 210 that illustrates a de-noise system is active, as well as a sub-indicator 210d that shows noise cancelation over time in graphical/wave form, e.g., illustrated in color contrast. Sub-indicator 210d can progressively illustrate the noise level in the user's environment and the activity of the de-noise system to mitigate that noise as detected by the second user.

As noted herein, aspects of the device 20 can be integrated into an audio device 30, e.g., an interface at the audio device 30. In such cases, the visual indicator 210 (and in some cases, additional aspects of the interface 200) can be integrated into the interface at audio device 30 to control that device 30. In certain examples, the visual indicator 210 (and in some cases, additional aspects of the interface 200) can be integrated into the housing of an audio device 30, such as on a top or side of the audio device housing. Further, the visual indicator 210 can be provided in an interface 200 such as in a vehicle audio system interface, e.g., a central control interface such as a dashboard display, head unit display, or other display.

In any case, the approaches described according to various implementations have the technical effect of enhancing audio awareness and control for a user in a communication mode. The visual indicators described herein can make users more aware of their environment, and enhance the experience for other users participating in a communication mode. Further, the visual indicators can effectively and efficiently notify a user that she is in a noisy environment without interrupting the communication mode and/or without sacrificing noise reduction features of an audio device. In particular cases where the audio device includes active and/or passive noise reduction, the visual indicators can significantly enhance the communication audio experience for user(s) on the other end of a communication.

Control device 20 and audio device(s) 30 can be controlled via a communications link which can include wireless pairing. Pairing can be performed via any wireless approach described herein (e.g., wireless pairing based on Wi-Fi, RF, BT and/or BLE), and/or via a hard-wired pairing approach such as a setup pairing via a hard-wired connection such as a variation of Universal Serial Bus (USB), High Definition Multimedia Interface (HDMI), etc. Various wireless connection scenarios are described herein. It is understood that any number of wireless connection and/or communication protocols can be used to couple devices in a space. Examples of wireless connection scenarios and triggers for connecting wireless devices are described in further detail in U.S. patent application Ser. Nos. 17/714,253 (filed on Apr. 4, 2022) and 17/314,270 (filed on May 7, 2021), each of which is hereby incorporated by reference in its entirety).

It is further understood that any RF protocol could be used to communicate between devices according to implementations, including Bluetooth, Wi-Fi, or other proprietary or non-proprietary protocols. In implementations that utilize Bluetooth LE Audio, a unicast topology could be used for a one-to-one connection between speakers and/or devices in a space. In some implementations, an LE Audio broadcast topology (such as Broadcast Audio) could be used to transmit one or more sets of audio data to multiple sets of speakers.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the coordinated audio output aspects according to the approaches described above.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A method comprising:
detecting use of a communication mode by an audio device, and
providing a visual indicator that a de-noise system is available to mitigate noise in the communication mode.

2. The method of claim 1, further comprising:
detecting noise in ambient sound during use of the communication mode;
comparing the detected noise with a threshold, and
activating the de-noise system in response to the detected noise satisfying the threshold.

3. The method of claim 2, wherein the threshold is based on a type of the audio device.

4. The method of claim 2, further comprising at least one of:
a) altering the visual indicator to indicate that the de-noise system is active, or
b) adjusting the visual indicator in response to a change in the detected noise,
wherein the visual indicator includes at least one of a progressive or regressive indicator function that is updated in response to the changes in detected noise.

5. The method of claim 1, wherein the visual indicator further indicates activity of the de-noise system, and wherein the method further includes providing a prompt to activate the de-noise system in response to detecting noise in ambient sound during use of the communication mode.

6. The method of claim 1, wherein the audio device comprises an occluding wearable audio device.

7. The method of claim 1, wherein the communication mode includes at least one of a phone call, a video call, or a meeting including audio communication.

8. The method of claim 1, wherein the visual indicator is at least one of:
a) presented on a visual interface and enables activation of the de-noise system with a command at the visual interface, or
b) presented to a first user of the communication mode and includes a representation of an amount of noise that is detectable by a second user of the communication mode.

9. The method of claim 1, wherein the visual indicator includes at least one of:
a) an icon that is present at an interface in both an active mode and an inactive mode, or
b) a multi-function indicator.

10. The method of claim 1, wherein the visual indicator is provided on one of: a) a vehicle interface, or b) a smart device or a computing device acting as an audio gateway device.

11. The method of claim 1, wherein processing that detects use of the communication mode by the audio device and provides the visual indicator is performed at a smart device or a computing device.

12. The method of claim 1, wherein processing that detects use of the communication mode by the audio device is performed at the audio device.

13. The method of claim 1, further comprising receiving an input from a user interface including a sensor at the audio device.

14. An audio device comprising:
an electro-acoustic transducer;
a microphone; and
a controller coupled with the electro-acoustic transducer and the microphone, the controller configured to:
detect use of a communication mode by the audio device, and
send instructions to a connected display device to provide a visual indicator that a de-noise system is available to mitigate noise in the communication mode.

15. The audio device of claim 14, wherein the controller is further configured to:
using the microphone, to detect noise in ambient sound during use of the communication mode,
compare the detected noise with a threshold, and
activate the de-noise system in response to the detected noise satisfying the threshold,
wherein the threshold is based on a type of the audio device.

16. The audio device of claim 14, wherein the visual indicator further indicates activity of the de-noise system, the controller further configured to provide a prompt to activate the de-noise system in response to detecting noise in ambient sound during use of the communication mode.

17. The audio device of claim 14, wherein the communication mode includes at least one of a phone call or a video call managed by an audio gateway device.

18. The audio device of claim 14, wherein the visual indicator is presented on:
a) a visual interface at the connected display device and enables activation of the de-noise system with a command at the visual interface, or
b) to a first user of the communication mode and includes a representation of an amount of noise that is detectable by a second user of the communication mode.

19. A system comprising:
a visual display;
a communications system; and
a controller coupled with the visual display and the communications system, the controller configured to:
detect use of a communication mode by a connected audio device; and
provide an indicator at the visual display that a de-noise system is available to mitigate noise in the communication mode.

20. The system of claim 19, wherein the controller is further configured to:
detect noise in ambient sound during use of the communication mode,
compare the detected noise with a threshold, and
activate the de-noise system in response to the detected noise satisfying the threshold,
wherein the indicator at the visual display indicates that the de-noise system is active.
